(19) United States
(12) Patent Application Publication
(10) Pub. No.: US 2026/0202570 A1
(43) Pub. Date: Jul. 16, 2026

(54) METHOD FOR ARRANGING WATER EXPLORATION STRUCTURE BASED ON BOREHOLE-TUNNEL INDUCED POLARIZATION AND METHOD FOR INVERSION WATER EXPLORATION BY USING THE SAME

(71) Applicant: SHANDONG UNIVERSITY, Jinan (CN)

(72) Inventors: Shucai LI, Jinan (CN); Zhengyu LIU, Jinan (CN); Bin LIU, Jinan (CN); Qian GUO, Jinan (CN); Yongheng ZHANG, Jinan (CN); Yumei CAI, Jinan (CN)

(21) Appl. No.: 19/540,647

(22) Filed: Feb. 14, 2026

Related U.S. Application Data
(63) Continuation of application No. PCT/CN2023/128742, filed on Oct. 31, 2023.

(30) Foreign Application Priority Data
Aug. 21, 2023 (CN) 2023110545935

(51) Int. Cl. G01V 3/02; E21F 17/18; G01V 3/38

(52) U.S. Cl. CPC G01V 3/02; E21F 17/18; G01V 3/38

(57) ABSTRACT

A method for arranging a water detection structure based on borehole-tunnel induced polarization. The arranging method may comprise: arranging a plurality of forward boreholes at intervals on the outer edge area of the tunnel face; arranging borehole detection cables in each forward borehole, wherein each borehole detection cable comprises a plurality of detection electrodes, and each detection electrode in a borehole detection cable is respectively configured as a power supply electrode A, a power supply electrode B; arranging a plurality of the out-of-borehole detection electrodes in an array on the tunnel face outside an area occupied by the plurality of forward boreholes, wherein each out-of-borehole detection electrode is configured as a measuring electrode M, a measuring electrode N; the power supply electrodes form a closed power supply circuit, while the measuring electrodes form a closed measuring circuit.

### CROSS-REFERENCE TO RELATED APPLICATIONS

This patent application claims the priority benefits of Chinese Patent Application No. 202311054593.5, entitled “METHOD FOR ARRANGING WATER EXPLORATION STRUCTURE BASED ON BOREHOLE-TUNNEL INDUCED POLARIZATION AND METHOD FOR INVERSION WATER EXPLORATION BY USING THE SAME” filed on Aug. 21, 2023, with the China National Intellectual Property Administration, the invention of which is incorporated by reference herein in its entirety as a part of the present application for all purposes.

### TECHNICAL FIELD

The present invention relates to the technical field of geophysical exploration, in particular, to a method for arranging a water detection structure based on borehole-tunnel induced polarization and a method for inversion water detection by using the same.

### BACKGROUND

Currently, in numerous tunnel construction projects, deep-buried tunnels in rugged mountainous regions and tunnels crossing rivers and seas are emerging in large numbers, characterized by extended tunnel lengths and significant burial depths. Various types of water-bearing/water-conducting adverse geologies are more concealed, have higher disaster-causing potential, and require higher exploration resolution. These factors collectively make the targets more difficult to detect. Under conditions of unclear detection, water inrush disasters are easily induced during tunnel construction, which places higher demands and challenges on the accuracy of tunnel advanced detection.

Induced polarization is an electrical exploration method that utilizes the induced polarization effect in water-bearing geological bodies for detection, exhibiting high sensitivity to water bodies. Currently, in this field, tunnel advanced water detection methods based on induced polarization techniques—such as Bore-Tunneling Electrical Ahead Monitoring (BEAM) and Transient Induced Polarization (TIP)—have been applied for advanced forecasting of water-bearing structure in tunnels. Among these, the TIP method can achieve localization and quantitative prediction of large water-bearing structure.

However, the aforementioned method utilizes the tunnel sidewalls and tunnel face for detection.

(1) Due to the confined space of tunnels, detection resolution is typically at the meter level, making it difficult to achieve fine detection of small water-bearing and water-conducting structure. Secondly, the induced polarization field generated by the aforementioned method is distributed near the tunnel, resulting in poor response to distant water-bearing structure which in turn leads to relatively short detection distances for these methods, failing to meet the requirements for exploring water-bearing structure at greater distances.

(2) Meanwhile, in the processing and imaging of induced polarization data, traditional polarizability inversion relies on resistivity inversion results, which approach introduces significant non-uniqueness factors from the resistivity inversion into the imaging, making polarizability inversion difficult to converge. Furthermore, the polarizability itself possesses natural boundary conditions within the interval (0, 1] interval. Traditional inversion methods often disregard the natural boundary condition, leading to polarizability values exceeding the permissible range and preventing reliable inversion results. Simultaneously, induced polarization belongs to potential field detection, which is inherently affected by volume effects, making it difficult to detect the boundary information of anomalous bodies, thereby preventing precise inversion imaging of anomalous body boundaries and leading to inaccurate geological interpretation.

Additionally, polarization detection requires high data accuracy, so it is necessary to focus on initial observation errors stemming from electrode polarization and multi-core cable coupling. The former arises from continuous power supply and measurement via metal electrodes, while the latter results from simultaneous power supply and measurement of multiple electrodes in a single multi-core cable.

### SUMMARY

Therefore, the present invention provides a method for arranging water exploration structure based on borehole-tunnel induced polarization and method for inversion water exploration by using the same, which improves the detection range of the induced polarization field for the target. By inducing polarization within the borehole and receiving at the tunnel face, three-dimensional effective information of the water-bearing/water-conducting structure ahead can be obtained. The approach avoids the problem of continuous power supply and measurement from a single metal electrode, as well as simultaneous power supply and measurement from multiple electrodes on the same cable. Fundamentally eliminating systematic interference caused by electrode polarization and multi-core cable coupling, making it suitable for high-precision induced polarization detection.

The present application provides a method for arranging water exploration structure based on borehole-tunnel induced polarization, comprising the following steps:
spacing multiple forward boreholes randomly along the outer edge area of the tunnel face;
arranging an in-borehole detection cable respectively in each of the forward boreholes, the in-borehole detection cable comprising a plurality of detection electrodes;
for any two detection electrodes among each detection cable in the borehole, configuring them respectively as the power supply electrode A and the power supply electrode B according to their distance relationship relative to the tunnel face, wherein the detection electrode closer to the tunnel face is defined as the power electrode A, and the detection electrode farther from the tunnel face is defined as the power electrode B; that is, the power supply electrode A is located between the tunnel face and the power supply electrode B;
on the tunnel face, in the area outside the area occupied by the plurality of forward boreholes, arranging a plurality of out-of-borehole detection electrodes in an array; selecting any two of these out-of-borehole detection electrodes, defining one as the measuring electrode M and the other as the measuring electrode N; and
forming the power supply electrode A and the power supply electrode B as a power supply closed circuit, while forming the measuring electrode M and the measuring electrode N as a measuring closed circuit.

The present application also provides a method for inversion water exploration, implemented by the arranged water detection structure utilizing borehole-tunnel induced polarization. The water detection method comprises:
the initial observation data acquisition step, for obtaining the induced polarization data generated by the borehole-tunnel induced polarization water detection structure, employing the following specific steps:
defining any one of a plurality of forward boreholes as the first borehole;
selecting any two detection electrodes from the plurality of detection electrodes within the borehole detection cable in the first borehole, defining one as the power supply electrode A and the other as the power supply electrode B, and supplying power so that the power electrode A and the power supply electrode B form a power closed circuit; wherein the detection electrode closer to the tunnel face is defined as the power supply electrode A, and the detection electrode farther from the tunnel face is defined as the power supply electrode B, so that the power supply electrode A is located between the tunnel face and the power supply electrode B;
selecting any two electrodes from the out-of-borehole detection electrodes, defining one as the measuring electrode M and the other as the measuring electrode N, and supplying power to form a measuring closed circuit between the measuring electrode M and the measuring electrode N, thereby obtaining initial observation data under the state;
according to the aforementioned method, all detection electrodes in the in-borehole detection cable within the first borehole and the out-of-borehole detection electrodes are traversed and measured, thereby obtaining initial observation data based on the first borehole; and
based on the observation method derived from the initial observation data of the first hole, the corresponding initial observation data for the remaining boreholes are obtained sequentially.

In some examples, the water detection method further comprises:
an initial observation data screening step: calculating the initial observation data, obtained from each borehole during the initial observation data acquisition step, using the formula according to the following geometric factor G; discarding the corresponding initial observation data when G exceeds the preset threshold to generate the detection observation data:

$$G = \frac{4 π}{( \frac{1}{AM} + \frac{1}{{AM}^{′}} - \frac{1}{A N} - \frac{1}{{AN}^{′}} - \frac{1}{B M} - \frac{1}{{BM}^{′}} + \frac{1}{B N} + \frac{1}{{BN}^{′}} )} ;$$

wherein, AM, AN, BM and BN respectively represent the distances between each power supply electrode and measuring electrodes; AM′, AN′, BM′ and BN′ respectively represent the distances between the virtual electrode points, which are symmetrical to each power supply electrode with respect to the tunnel face, and the measuring electrodes.

In some examples, the preset value is 3000.

In some examples, the water detection method further comprises:
establishing a corresponding resistivity initial model and an initial polarizability model based on the detection observation data. Then, performing conventional electrical inversion based on the resistivity initial models to obtain a resistivity inversion model;
establishing a tunnel resistivity-polarizability clustering joint inversion objective function;
based on the tunnel resistivity-polarizability clustering joint inversion objective function, finding the minimum value of the tunnel resistivity-polarizability clustering joint inversion objective function, constructing the inversion equation based on the function, updating model parameter increments, and obtaining the final inversion result after iterative inversion;
outputting the apparent polarizability and the apparent resistivity of the cross-section y=0 in the inversion result to image the tunnel ahead;
identifying whether there is water-bearing/water-conducting adverse geology ahead of the tunnel based on the boundary information of the water-bearing body indicated in the imaging results; and
when water-bearing/water-conducting adverse geology is identified ahead of the tunnel, taking measures such as grouting to stop water, water diversion, and drainage shall be implemented for the water-bearing/water-conducting adverse geology.

In some examples,
the joint inversion objective function for the tunnel resistivity and polarizability clustering is:

$$Φ = {Φ}_{σ} + μ {Φ}_{η} + {λ}_{1} {Φ}_{F C M} + {λ}_{2} {Φ}_{log} ,$$

$${Φ}_{σ} = {Φ}_{d σ} + {β}_{σ} {Φ}_{m σ} ,$$

$${Φ}_{η} = {Φ}_{d η} + {β}_{η} {Φ}_{m η} ;$$

wherein, Φ_{σ} is the sum of the resistivity data term and the model term of conventional inversion; Φ_{η} is the sum of the polarizability term and the model term of conventional inversion; μ is the weight parameter balancing the resistivity and the polarizability models; Φ_{FCM} is the clustering term, λ₁ is a parameter determining the applied clustering weight term; Φ_{log} is the boundary constraint term, and λ₂ is the boundary constraint parameter; β_{σ} and β_{η} are the regularization parameter; Φ_{dσ} is the resistivity data term, Φ_{mσ} is the resistivity model term, Φ_{dη} is the polarizability data term, and is the polarizability model term.

In some examples,

$${Φ}_{F C M} = {\sum }_{j = 1}^{M} {\sum }_{k = 1}^{C} {u}_{j k}^{q} ( {‖ {m}_{σ , j} - {v}_{k 1} ‖}^{2} + ξ {‖ {m}_{η , j} - {v}_{k 2} ‖}^{2} ) + {\sum }_{k = 1}^{C} ω {‖ {v}_{k} - {t}_{k} ‖}^{2} ;$$

wherein, m_{σ} is the resistivity vector of the model, m_{η} is the polarizability vector of the model, vₖ₁ is the first cluster center (resistivity value) of the k^{th} class, vₖ₂ is the second cluster center (polarizability value) of the k^{th} class, and vₖ₁ and vₖ₂ are added according to the weight ξ;

$${u}_{j k}^{q}$$

represents the membership degree of the j^{th} unit with respect to the k^{th} class; tₖ is the target cluster center provided by known prior petrophysical information; in the vector ω=(ω₁, ω₂, . . . , ωₖ)^{T}, the magnitude of each parameter element ωₖ is determined by the reliability of the k^{th} prior cluster center; q is the fuzzification factor, which is a constant.

In some examples:

$${Φ}_{log} = - 2 \{ {\sum }_{k = 1}^{M} ln ( \frac{{m}_{η}}{u} ) + {\sum }_{k = 1}^{M} ln ( 1 - \frac{{m}_{η}}{u} ) \} ;$$

wherein, u is the upper bound of the constraint, and M is the number of model parameters;
and/or,

$${u}_{j k}^{q} = \frac{{‖ {m}_{σ} - {v}_{k 1} ‖}^{- \frac{2}{q - 1}} + ξ {‖ {m}_{η} - {v}_{k 2} ‖}^{- \frac{2}{q - 1}}}{{\sum }_{i = 1}^{C} ( {‖ {m}_{σ} - {v}_{i 1} ‖}^{- \frac{2}{q - 1}} + ξ {‖ {m}_{η} - {v}_{i 2} ‖}^{- \frac{2}{q - 1}} )} ;$$

$$and / or ,$$

$${v}_{k 1} = \frac{{\sum }_{j = 1}^{M} {u}_{j k}^{q} {m}_{σ , j} + {ω}_{k} {t}_{k}}{{\sum }_{j = 1}^{M} {u}_{j k}^{q} + {ω}_{k}} , {v}_{k 2} = \frac{{\sum }_{j = 1}^{M} {u}_{j k}^{q} {m}_{η , j} + {ω}_{k} {t}_{k}}{{\sum }_{j = 1}^{M} {u}_{j k}^{q} + {ω}_{k}} .$$

In some examples, the inversion equation for resistivity model increment Δm_{σ} is:

$$( {J}_{σ}^{T} {W}_{d}^{T} {W}_{d} {J}_{σ} + {β}_{σ} {W}_{m}^{T} {W}_{m} + {λ}_{1} {\sum }_{k = 1}^{C} {U}_{k} ) Δ {m}_{σ} = {J}_{σ}^{T} {W}_{d}^{T} {W}_{d} Δ {d}_{σ} - {β}_{σ} {W}_{m}^{T} {W}_{m} ( {m}_{σ} - {m}_{σ}^{ref} ) - {λ}_{1} {\sum }_{k = 1}^{C} {U}_{k} ( {m}_{σ} - {v}_{k 1} ) ;$$

wherein, J_{σ} is the sensitivity matrix of resistivity, β_{σ} is the damping factor (a constant set empirically) for the resistivity model constraint term, C is the number of clusters, Uₖ is the membership degree matrix of a grid belonging to the k^{th} cluster, Δd_{σ} is the data difference vector of resistivity, which is the difference between measured and predicted data, m_{σ} is the resistivity value,

$${m}_{σ}^{ref}$$

is the resistivity reference model, and vₖ₁ is the resistivity cluster center for the k^{th} cluster;
and/or, the iterative update equation for the polarizability boundary constraint parameter λ₂ is:

$$\{ \begin{matrix}{ζ}_{-} = {min}_{Δ {m}_{j} < 0} \frac{{m}_{j}}{\vert Δ {m}_{j} \vert} \\ {ζ}_{+} = {min}_{Δ {m}_{j} > 0} \frac{u - {m}_{j}}{Δ {m}_{j}}\end{matrix} , ζ = min ( {ζ}_{-} , {ζ}_{+} ) , {λ}_{2} = {λ}_{2} [ 1 - min ( γ , ζ ) ] ;$$

wherein, ζ₋ and ζ₊ are two intermediate variables, and the final calculation ζ is also an intermediate coefficient used to update λ₂, while γ is a constant.

In some examples, the inversion equation for the polarizability model increment Δm_{η} is:

$$( {J}_{η}^{T} {W}_{d}^{T} {W}_{d} {J}_{η} + {β}_{η} {W}_{m}^{T} {W}_{m} + {λ}_{1} {\sum }_{k = 1}^{C} {U}_{k} + {λ}_{2} {X}^{- 2} + {λ}_{2} {Y}^{- 2} ) Δ {m}_{η} = {J}_{η}^{T} {W}_{d}^{T} {W}_{d} Δ {d}_{η} - {β}_{η} {W}_{m}^{T} {W}_{m} ( {m}_{η} - {m}_{η}^{ref} ) - {λ}_{1} {\sum }_{k = 1}^{C} {U}_{k} ( {m}_{η} - {v}_{k 2} ) + {λ}_{2} ( {X}^{- 1} - {Y}^{- 1} ) e ;$$

wherein,

$$X = diag ( {m}_{1} , {m}_{2} , … , {m}_{M} ) , Y = u I - X , e = {[ \begin{matrix}1 & 1 & L & 1\end{matrix} ]}_{M}^{T} ,$$

wherein, J_{η} is the sensitivity matrix of the polarizability, Δd_{η} is the difference vector of the observed polarizability data, which is the difference between the observed and predicted polarizability data, vₖ₂ is the polarizability cluster center for the k^{th} cluster, and e is a column vector of dimension M;

$${λ}_{2} = \frac{{‖ {w}_{d} ( {d}_{η}^{obs} - {d}_{η} ) ‖}^{2} + {β}_{η} {‖ {W}_{m} ( {m}_{η} - {m}_{η}^{ref} ) ‖}^{2}}{- 2 {\sum }_{j = 1}^{M} [ ln ( \frac{{m}_{η , j}}{u} ) + ln ( 1 - \frac{{m}_{η , j}}{u} ) ]} ;$$

wherein, W_{d} is a data weighting matrix,

$${d}_{η}^{obs}$$

is the observed polarizability data, d_{η} is the simulated polarizability data, β_{η} is the damping factor for the polarizability model constraint term, Wₘ is the smoothness constraint matrix, m_{η} is the polarizability,

$${m}_{η}^{ref}$$

is the reference model for polarizability, and u is the upper bound for polarizability.

The present application which provides a method for arranging water exploration structure based on borehole-tunnel induced polarization and method for inversion water exploration by using the same has the following beneficial effects:
by arranging multiple forward boreholes on the tunnel face and setting detection electrodes within each forward borehole, this present application overcomes the limitations of traditional detection techniques constrained by the confined space of the tunnel. Arranging the detection elements (i.e., detection electrodes) within the forward boreholes enables close-range detection, effectively enhancing the response of the induced polarization field to detection targets and extending the detection range. This present application resolves the longstanding challenge that small water-bearing/water-conducting structure ahead of the tunnel could not be detected or detected clearly; The borehole-tunnel induced polarization in the present application adopts a four-electrode observation method with a four-electrode array. By inducing inside the borehole and receiving signals at the tunnel face, three-dimensional effective information about water-bearing structure ahead can be obtained. By dispersing the power supply electrode pairs and measuring electrode pairs into the forward boreholes and the tunnel face, the problems of continuous power supply and measurement from a single metal electrode, as well as simultaneous power supply and measurement from multiple electrodes on the same cable are avoided, fundamentally eliminating system interference caused by electrode polarization and multi-core cable coupling, making it suitable for high-precision induced polarization detection;
this present application establishes a clustering constraint term for inversion, performs cluster analysis on resistivity and polarizability, and incorporates a regularized inversion process, which leverages the advantages of cluster analysis in boundary delineation to achieve high-precise characterization of water body boundaries ahead of the tunnel. A joint resistivity-polarizability inversion framework is established, enabling simultaneous inversion of resistivity and polarizability within a single objective inversion function, which reduces the dependence of polarizability inversion on resistivity inversion results, ensuring convergence of the inversion process. For the three-dimensional polarizability model inversion, boundary constraints are added and integrated into the joint inversion framework, ensuring the polarizability data conforms to its natural boundary limits, thereby avoiding the defects of excessively small numerical values in the polarizability inversion model and data deviation from the actual model.

### BRIEF DESCRIPTION OF THE DRAWINGS

FIG. 1 is a schematic side view of the borehole-tunnel induced polarization water detection structure according to an example of the present invention;

FIG. 2 is a front view of the borehole-tunnel induced polarization water detection structure according to an example of the present invention (i.e., as viewed from the tunnel face);

FIG. 3 is a schematic diagram of the borehole-tunnel induced polarization four-electrode observation method;

FIG. 4 is a schematic diagram of the geometric factor calculation G;

FIG. 5 is the flowchart of the tunnel induced resistivity and polarizability clustering joint inversion in an example of the present invention;

FIG. 6 is a schematic diagram of the geoelectric model used in the numerical simulation of the present invention;

FIG. 7A is a schematic diagram of the imaging results of the apparent polarizability obtained by the clustering joint inversion method in an example of the present invention;

FIG. 7B is a schematic diagram of the apparent polarizability imaging result of the conventional sequential inversion method in an example of the present invention;

FIG. 8A is a schematic diagram of the apparent resistivity imaging result of using the clustering joint inversion method in an example of the present invention;

FIG. 8B is a schematic diagram of the apparent resistivity imaging result of using the conventional sequential inversion method in an example of the present invention;

The figure markings are as follows:
1. Tunnel cavity; 2. Forward borehole; 3. Electrode in-borehole point; 4. Array electrode point; 5. Power supply electrode A; 6. Power supply electrode B; 7. Measuring electrode M; 8. Measuring electrode N.

### DETAILED DESCRIPTION

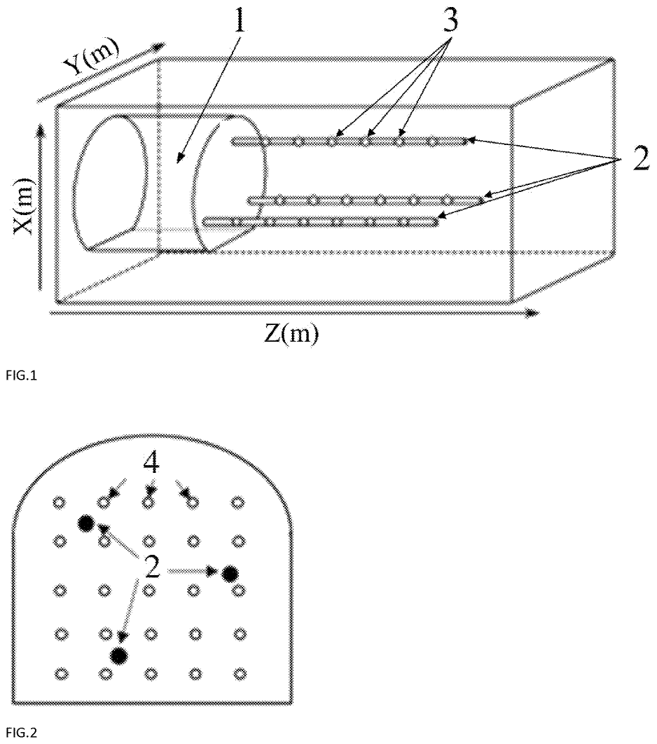

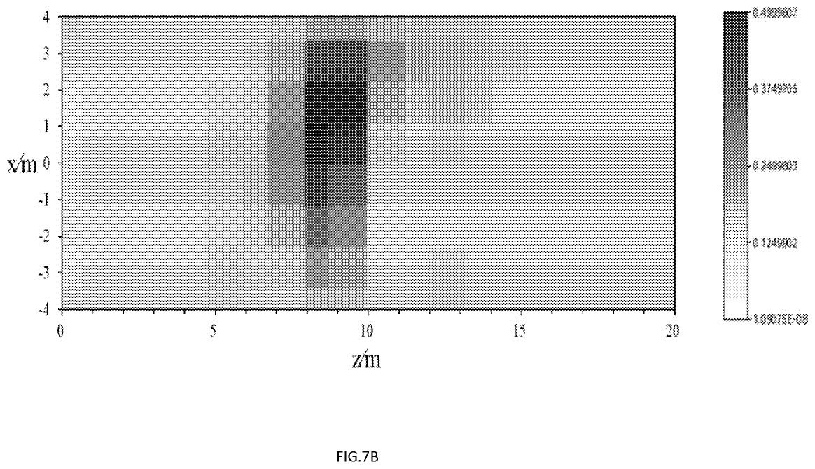

Referring to FIG. 1 to FIG. 8, an example of the present invention provides a method for arranging a water detection structure based on borehole-tunnel induced polarization, comprising the following steps:
arranging a plurality of forward boreholes 2 at intervals along the outer edge area of the tunnel face;
in each of the forward boreholes 2, installing an in-borehole detection cable, where the in-borehole detection cable has a plurality of detection electrodes, for any two detection electrodes in each in-borehole detection cable, based on their distance relative to the tunnel face, respectively configuring them as power supply electrode A5 and power supply electrode B6; wherein the detection electrode closer to the tunnel face is defined as power supply electrode A5, and the detection electrode farther from the tunnel face is defined as power supply electrode B6; that is, power supply electrode A5 is located between the tunnel face and power supply electrode B6;
on the tunnel face, outside the area occupied by the plurality of forward boreholes 2, arranging a plurality of out-of-borehole detection electrodes in an array, selecting any two electrodes from the plurality of out-of-borehole detection electrodes, with one defined as measuring electrode M7 and the other as measuring electrode N8;
forming the power supply electrodes A5 and B6 as a power supply closed circuit, while forming the measuring electrodes M7 and N8 as a measuring closed circuit.

In the technical solution, by arranging a plurality of forward boreholes 2 on the tunnel face and arranging detection electrodes in each borehole 2, the limitations of traditional detection methods constrained by the tunnel's confined space have been overcome. The detection elements (i.e., detection electrodes) are arranged in forward boreholes 2 to achieve close-range detection, effectively enhancing the response of the induced polarization field to detection targets, extending detection range, and resolving the previous challenges of undetectable and unclear small water-bearing/water-conducting structure ahead of the tunnel. The borehole-tunnel induced polarization in the present invention employs a four-electrode observation method using a four-electrode observation array. By in-borehole inducing and receiving at the tunnel face, three-dimensional effective information on forward water-bearing/water-conducting structure can be obtained. By dispersing the power supply electrode pairs and measuring electrode pairs into the forward borehole and the tunnel face, the approach avoids the issues of continuous power supply and measurement from a single metal electrode, as well as simultaneous power supply and measurement from a plurality of electrodes on the same cable, fundamentally eliminating system interference caused by electrode polarization and multi-core cable coupling, making it suitable for high-precision induced polarization detection.

According to an example of the present invention, a water detection method based on inversion technology is provided, implemented by the aforementioned water detection structure based on borehole-tunnel induced polarization. The water detection method comprises:
the initial observation data acquisition step, for obtaining the induced polarization data generated by the arranged borehole-tunnel induced polarization water detection structure, comprising the following specific steps:
defining any one of a plurality of forward boreholes as the first borehole. Selecting any two detection electrodes from the plurality of detection electrodes in the in-borehole detection cable in the first borehole, defining one as power supply electrode A5 and the other as power supply electrode B6. Supplying power so that the power supply electrode A5 and power supply electrode B6 forming a power supply closed circuit; wherein the detection electrode closer to the tunnel face is defined as power supply electrode A5, and the detection electrode farther from the tunnel face is defined as power supply electrode B6; that is, power supply electrode A5 is located between the tunnel face and power supply electrode B6;
selecting any two electrodes from the aforementioned out of detection electrodes, defining one as measuring electrode M7 and the other as measuring electrode N8, and supplying power so that measuring electrodes M7 and N8 forming a measuring closed circuit, thereby acquiring the initial observation data under the state;
according to the aforementioned method, traversing and measuring each detection electrode in the all in-borehole detection cables in the first borehole and the out-of-borehole detection electrodes, thereby obtaining initial observation data based on the first borehole;
according to the observation method based on the initial observation data of the first hole, obtaining the corresponding initial observation data for the remaining boreholes sequentially.

Specifically, by traversing each detection electrode in each forward borehole 2 (the power supply electrode pair comprised of power supply electrode A and power supply electrode B) with each detection electrode on the tunnel face (the measuring electrode pair comprised of measuring electrode M and measuring electrode N pair), three-dimensional effective information can be acquired over a significant distance ahead of the tunnel face, which enables precise detection, ensures the accuracy of the results.

In some examples, the inversion water exploration method further comprises:
initial observation data screening step, to calculate the initial observation data obtained for each borehole in the initial observation data acquisition step according to the following formula of geometric factor G and discarding the corresponding initial observation data when G exceeds the preset value to generate the detection observation data:

$$G = \frac{4 π}{( \frac{1}{AM} + \frac{1}{{AM}^{′}} - \frac{1}{AN} - \frac{1}{{AN}^{′}} - \frac{1}{BM} - \frac{1}{{BM}^{′}} + \frac{1}{BN} + \frac{1}{{BN}^{′}} )} ;$$

wherein, AM, AN, BM and BN respectively represent the distances between each power supply electrode and measuring electrodes; AM′, AN′, BM′ and BN′ respectively represent the distances between the virtual electrode points, which are symmetrical to each power supply electrode with respect to the tunnel face, and the measuring electrodes.

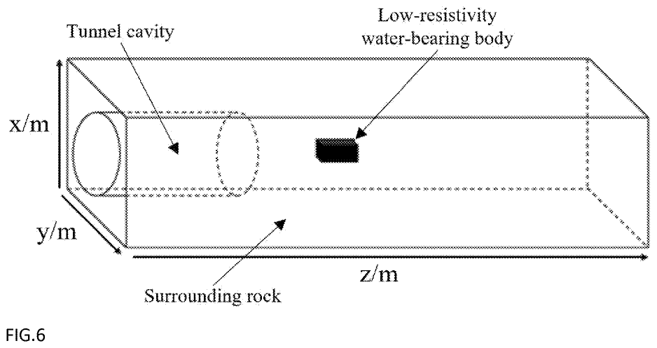

As illustrated in FIG. 4, the diagram only shows the relative distance between the power supply electrode A5 and the measuring electrode M7 on the tunnel face. In the figure, A′ is the virtual electrode point symmetrical to the power electrode A5 relative to the tunnel face, thereby obtaining the corresponding distances AM and AM′. The relevant distances for other detection electrodes follow the same principle and will not be described in detail.

In a specific example, the preset value is 3000. That is, observations with G exceeding 3000 are rejected, ultimately establishing an optimized effective observation mode for the borehole-tunnel induced polarization four-electrode. In this technical solution, data exceeding preset thresholds is filtered out based on geometric factors, which significantly reduces low signal-to-noise ratio or invalid data, ensuring the accuracy and validity of subsequent data.

In some examples, the inversion water exploration method further comprises:
establishing a corresponding resistivity initial model and an initial polarizability model based on the detection observation data. Then, performing conventional electrical inversion based on the resistivity initial model to obtain a resistivity inversion model;
establishing a tunnel resistivity-polarizability clustering joint inversion objective function;
minimizing the tunnel resistivity-polarizability clustering joint inversion objective function; constructing the inversion equation based on the tunnel resistivity-polarizability clustering joint inversion objective function; and updating the model parameter increments and obtaining the final inversion result after iterative inversion.

Specifically, the joint inversion objective function for the tunnel resistivity polarizability clustering is:

$$Φ = {Φ}_{σ} + μ {Φ}_{η} + {λ}_{1} {Φ}_{FCM} + {λ}_{2} {Φ}_{log} ,$$

$${Φ}_{σ} = {Φ}_{d σ} + {β}_{σ} {Φ}_{m σ} ,$$

$${Φ}_{η} = {Φ}_{d η} + {β}_{η} {Φ}_{m η} ;$$

wherein, Φ_{σ} represents the sum of the resistivity data term and the model term for conventional inversion. Φ_{η} represents the sum of the polarizability data term and the model term for conventional inversion, and y denotes the weight parameter balancing the resistivity and polarizability model terms. In the present invention, μ=1 is set so that resistivity and polarizability occupy the same weight in the data term and model term of the inversion. Φ_{FCM} is the clustering term, affecting the clustering behavior of two groups of petrophysical models—resistivity and polarizability—in the inversion. λ₁ is the parameter determining the weight of the clustering term. Φ_{log} is the boundary constraint term and λ₂ is the boundary constraint parameter which constrains the three-dimension polarizability model during inversion; β_{σ} and β_{η} are the regularization parameters, balancing the weights of data terms and model terms in the resistivity model and polarizability model, respectively; Φ_{dσ} is the resistivity data term, Φ_{mσ} is the resistivity model term, Φ_{dη} is the polarizability data term, and Φ_{mη} is the polarizability model term.

In this technical solution, a clustering constraint term was established for inversion performing cluster analysis on resistivity and polarizability, and incorporating a regularization process was into the inversion procedure, which leverages the advantage of cluster analysis in boundary delineation, enabling precise characterization of the water body boundary ahead of the tunnel. A joint resistivity-polarizability inversion framework is established, enabling simultaneous inversion of resistivity and polarizability within a single objective function, reducing the dependence of polarizability inversion on resistivity results, ensuring convergence of the inversion process. For the three-dimensional polarizability model inversion, boundary constraints are added and integrated into the joint inversion framework, which ensures the polarizability data conforms to its natural boundary limitations, thereby avoiding the defects of excessively small numerical values in the polarizability inversion model and data deviation from the actual model.

In the clustering term:

$${Φ}_{FCM} = {\sum }_{j = 1}^{M} {\sum }_{k = 1}^{C} {u}_{jk}^{q} ( {‖ {m}_{σ , j} - {v}_{k 1} ‖}^{2} + ξ {‖ {m}_{η , j} - {v}_{k 2} ‖}^{2} ) + {\sum }_{k = 1}^{C} ω {‖ {v}_{k} - {t}_{k} ‖}^{2} ;$$

wherein, m_{σ} represents the resistivity vector of the model, m_{η} represents the polarizability vector of the model, vₖ₁ denotes the first cluster center (resistivity value) of the k^{th} class, and vₖ₂ denotes the second cluster center (polarizability value) of the k^{th} class. These two values are added according to the weight ξ. According to statistical principles, when this term is minimized, all model units are considered correctly classified.

$${u}_{jk}^{q}$$

denotes the membership degree of the j^{th} unit relative to the k^{th} class; tₖ represents the target cluster centers provided by known prior petrophysical information. In the vector ω=(ω₁, ω₂, . . . , ωₖ)^{T}, the magnitude of each element parameter ωₖ depends on the reliability of the k^{th} prior cluster center. If the reliability of the cluster center provided by the k^{th} prior information is low, the value ωₖ is appropriately reduced; q is the fuzzification factor as a constant, typically set to 2.

In some examples:

$${Φ}_{log} = - 2 \{ {\sum }_{k = 1}^{M} ln ( \frac{{m}_{η}}{u} ) + {\sum }_{k = 1}^{M} ln ( 1 - \frac{{m}_{η}}{u} ) \} ;$$

wherein, u is the upper boundary of the constraint. Considering that the polarizability of the water-bearing body ahead of the tunnel is typically 0.3. Therefore, for tunnel borehole induced polarization detection in this invention, u=0.3 is set; M is the number of model parameters. Specifically, in practical applications, forward and inverse modeling are performed through discretization methods such as finite element. The model is divided into individual grids, where M is the total number of grids and also the total number of model parameters for each grid.

The initial value of λ₂ is:

$${λ}_{2} = \frac{{‖ {w}_{d} ( {d}_{η}^{obs} - {d}_{η} ) ‖}^{2} + {β}_{η} {‖ {W}_{m} ( {m}_{η} - {m}_{η}^{ref} ) ‖}^{2}}{- 2 {\sum }_{j = 1}^{M} [ ln ( \frac{{m}_{η , j}}{u} ) + ln ( 1 - \frac{{m}_{η , j}}{u} ) ]} ; \qquad ( 1 )$$

wherein, W_{d} is the data weighting matrix,

$${d}_{η}^{obs}$$

is the observed polarizability data, d_{η} is the simulated polarizability data (known as predicted data), β_{η} is the damping factor (a constant set empirically) for the polarizability model constraint term, Wₘ is the smoothing constraint matrix, m_{η} is the polarizability,

$${m}_{η}^{ref}$$

is the reference polarizability model, and u is the upper bound of polarizability;
the inversion equations for the membership degree

$${u}_{jk}^{q}$$

and the cluster centers vₖ₁ and vₖ₂ are respectively:

$${u}_{jk}^{q} = \frac{{‖ {m}_{σ} - {v}_{k 1} ‖}^{- \frac{2}{q - 1}} + ξ {‖ {m}_{η} - {v}_{k 2} ‖}^{- \frac{2}{q - 1}}}{{\sum }_{i = 1}^{C} ( {‖ {m}_{σ} - {v}_{i 1} ‖}^{- \frac{2}{q - 1}} + ξ {‖ {m}_{η} - {v}_{i 2} ‖}^{- \frac{2}{q - 1}} )} ; \qquad ( 2 )$$

$$and / or ,$$

$${v}_{k 1} = \frac{{\sum }_{j = 1}^{M} {u}_{jk}^{q} {m}_{σ , j} + {ω}_{k} {t}_{k}}{{\sum }_{j = 1}^{M} {u}_{jk}^{q} + {ω}_{k}} , {v}_{k 2} = \frac{{\sum }_{j = 1}^{M} {u}_{jk}^{q} {m}_{η , j} + {ω}_{k} {t}_{k}}{{\sum }_{j = 1}^{M} {u}_{jk}^{q} + {ω}_{k}} . \qquad ( 3 )$$

And/or,
the inversion equation for resistivity model increment Δm_{σ} is:

$$( {J}_{σ}^{T} {W}_{d}^{T} {W}_{d} {J}_{σ} + {β}_{σ} {W}_{m}^{T} {W}_{m} + {λ}_{1} {\sum }_{k = 1}^{c} {U}_{k} ) Δ {m}_{σ} = {J}_{σ}^{T} {W}_{d}^{T} {W}_{d} {Δd}_{σ} - {β}_{σ} {W}_{m}^{T} {W}_{m} ( {m}_{σ} - {m}_{σ}^{ref} ) - {λ}_{1} {\sum }_{k = 1}^{c} {U}_{k} ( {m}_{σ} - {v}_{k 1} ) ; \qquad ( 4 )$$

wherein, J_{σ} is the sensitivity matrix of resistivity, β_{σ} is the damping factor (a constant set empirically) for the resistivity model constraint term, C is the number of clusters, Uₖ is the membership degree matrix of a grid belonging to the k^{th} cluster, Δd_{σ} is the data difference vector of resistivity, which is the difference between measured and predicted data, m_{σ} is the resistivity value,

$${m}_{σ}^{ref}$$

is the resistivity reference model, and vₖ₁ is the resistivity cluster center for the k^{th} cluster;
and/or, in some examples, the iterative update equation for the polarizability boundary constraint parameter λ₂ is:

$$\{ \begin{matrix}{ζ}_{-} = {min}_{Δ {m}_{j} < 0} \frac{{m}_{j}}{\vert Δ {m}_{j} \vert} \\ {ζ}_{+} = {min}_{Δ {m}_{j} > 0} \frac{u - {m}_{j}}{Δ {m}_{j}}\end{matrix} , ζ = min ( {ζ}_{-} , {ζ}_{+} ) , {λ}_{2} = {λ}_{2} [ 1 - min ( γ , ζ ) ] ; \qquad ( 5 )$$

wherein, ζ₋ and ζ₊ represent two intermediate variables respectively, and the final calculation ζ is also an intermediate coefficient used to update λ₂, and γ is a constant, typically set to 0.925.

The inversion equation for the polarizability model increment Δmy is:

$$( {J}_{η}^{T} {W}_{d}^{T} {W}_{d} {J}_{η} + {β}_{η} {W}_{m}^{T} {W}_{m} + {λ}_{1} {\sum }_{k = 1}^{C} {U}_{k} + {λ}_{2} {X}^{- 2} + {λ}_{2} {Y}^{- 2} ) Δ {m}_{η} {J}_{η}^{T} {W}_{d}^{T} {W}_{d} Δ {d}_{η} - {β}_{η} {W}_{m}^{T} {W}_{m} ( {m}_{η} - {m}_{η}^{r e f} ) - {λ}_{1} {\sum }_{k = 1}^{C} {U}_{k} ( {m}_{η} - {v}_{k 2} ) + {λ}_{2} ( {X}^{- 1} - {Y}^{- 1} ) e ; \qquad ( 6 )$$

wherein,

$$X = diag ( {m}_{1} , {m}_{2} , … , {m}_{M} ) , Y = u I - X , e = {[ \begin{matrix}1 & 1 & L & 1\end{matrix} ]}_{M}^{T} ,$$

wherein, J_{η} is the sensitivity matrix for the polarizability, Δd_{η} is the difference vector of the observed polarizability data, which is the difference between the observed and predicted polarizability data, vₖ₂ is the polarizability cluster center for the k^{th} cluster, and e is an M-dimensional column vector.

The following further elaborates on the technical solution of the present invention based on a specific example:
the water detection method of the present invention generally comprises two parts: data measurement and data processing imaging. The main contents are as follows:

### (1) Data Measurement

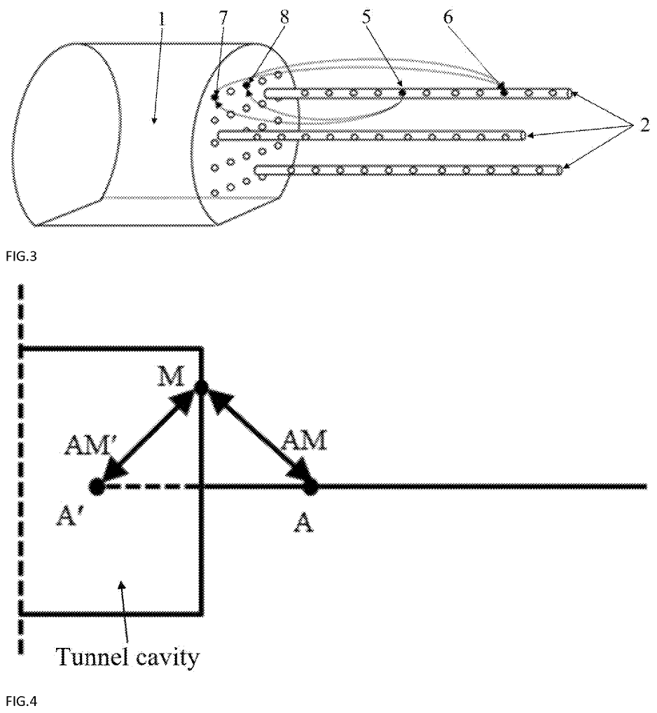

In a specific example, as shown in FIG. 1 and FIG. 2, three 65-meter-long forward boreholes 2 are drilled at the tunnel face. Horizontal cables (i.e., the in-borehole detection cables mentioned above, the same below) are arranged in each borehole. Thirty-two electrode points 3 (i.e., the detection electrodes mentioned above) are arranged on each cable at 2-meter intervals.

On the tunnel face (as previously described), 25 array electrodes 4 (i.e., the aforementioned out-of-borehole detection electrodes) are arranged outside the area occupied by the three forward boreholes 2. Each electrode point 3, 4 is connected to a cable. The above operation is called “wiring”.

In some examples of the present invention, the spacing between the aforementioned in-borehole electrode points 3 can be adjusted according to actual detection requirements. If a smaller spacing, such as 1 meter, is adopted, the detection resolution will correspondingly improve; conversely, it will decrease.

The number of electrodes arranged in each borehole may be adjusted based on actual conditions, but generally should not exceed 32.

After completing the wiring, generate the observation mode according to the predetermined observation method.

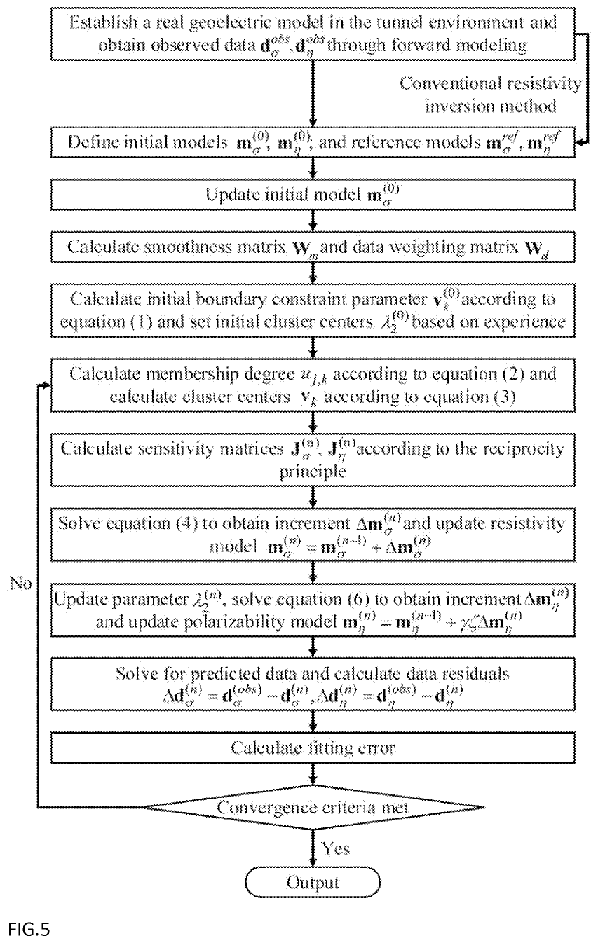

The detection employs a borehole-tunnel induced polarization four-electrode observation method, as shown in FIG. 3.

Taking the acquisition of one particular data point as an example, power supply electrode A5 and power supply electrode B6 are arranged within the same borehole, with power supply electrode A5 arranged closer to the tunnel face relative to power supply electrode B6d;

Measuring electrode M7 and measuring electrode N8 are arranged on the tunnel face, with their relative positions remaining unchanged.

When generating the observation mode, traverse all electrode points according to the aforementioned relative position rules. Considering the presence of three boreholes at the tunnel face, a total of 446,400 observation data points can be generated, constituting the preliminary borehole-tunnel induced polarization observation mode (the obtained data also serving as the initial observation detection data). However, the aforementioned data contains a large number of low signal-to-noise ratio or invalid data, so further screening is required.

For each data point in the generated preliminary observation mode, a geometric factor is calculated using the equation (1) and FIG. 4 referenced above. Then, data points with a geometric factor exceeding 3000 are filtered out based on this geometric factor. The remaining data points constitute the final borehole-tunnel induced polarization observation mode.

After completing the wiring, observation mode generation, and data screening, connect the cable to the host unit. Power on the host unit and connect it to the main control computer to commence data acquisition. Once data measurement is complete, proceed to data processing and imaging.

### (2) Data Processing and Imaging

(2.1) Establishing a geoelectric mode of low-resistivity body ahead of the tunnel, performing forward modeling on the geoelectric model to obtain two sets of observation data

$${d}_{σ}^{o b s}$$

(resistivity observation data) and

$${d}_{η}^{o b s}$$

(polarizability observation data), establishing two sets of initial models

$${m}_{σ}^{( 0 )} , {m}_{η}^{( 0 )}$$

spatially corresponding to these observation sets, conducting conventional electrical inversion on the resistivity initial model, because conventional electrical forward and inverse modeling are well known in the art and will not be elaborated upon here;
(2.2) calculating the initial values of the polarizability boundary constraint parameter

$${λ}_{2}^{( 0 )} ,$$

based on empirical settings, establish the initial cluster center vectors:

$${v}_{k}^{( 0 )} , {v}_{k 1}^{( 0 )} = {( {v}_{k 1}^{( 0 )} , {v}_{k 1}^{( 0 )} , … , {v}_{k 1}^{( 0 )} )}_{1 \times M}^{T} , {v}_{k 2}^{( 0 )} = {( {v}_{k 2}^{( 0 )} , {v}_{k 2}^{( 0 )} , … , {v}_{k 2}^{( 0 )} )}_{1 \times M}^{T} , … , k ∈ [ 0 , C ] ;$$

(2.3) calculating the membership degree

$${u}_{j , k}^{q , ( n )}$$

of each unit in the model and compute the cluster center vector

$${v}_{k}^{( 0 )}$$

for each cluster. In this present invention, setting ξ=1, the resistivity and polarizability have the same weight in the membership degree calculation. In this present invention, q=2 is set. Parameters ωₖ are determined according to the reliability of the prior clustering centers tₖ and ωₖ=1 is set;
(2.4) calculating the sensitivity matrix

$${J}_{σ}^{( n )}$$

for resistivity inversion and the sensitivity matrix for polarization inversion

$${J}_{η}^{( n )}$$

during the n iteration, while the sensitivity calculation is primarily based on the reciprocity principle, obtaining the resistivity model increment

$${m}_{σ}^{( 0 )}$$

and the polarizability model increment

$${m}_{η}^{( 0 )}$$

for the n iteration respectively and updating the resistivity model

$${m}_{σ}^{( n )} = {m}_{σ}^{( n - 1 )} + Δ {m}_{σ}^{( n )} .$$

In this present invention, β_{σ}=0.05 is set, indicating that the weight of the model term is 0.05 in the resistivity inversion; λ₁=0.01 is set, indicating that the weight of the clustering term is 0.01;
(2.5) updating the polarizability boundary constraint parameter λ₂;
wherein parameter γ serves to prevent the values of each unit in the model from precisely reaching the boundary, thereby allowing the logarithmic constraint iteration to proceed.

In some examples of the present invention, γ=0.925 is set;
(2.6) obtaining the polarizability model increment

$${m}_{η}^{( n )}$$

and update the polarizability model

$${m}_{η}^{( n )} = {m}_{η}^{( n - 1 )} + γζΔ {m}_{η}^{( n )} .$$

In some examples of the present invention, β_{η}=0.1 is set, indicating that the weight of the model term in the polarizability inversion is 0.1; and X=diag(m₁, m₂, . . . , m_{M}), Y=ul−X.

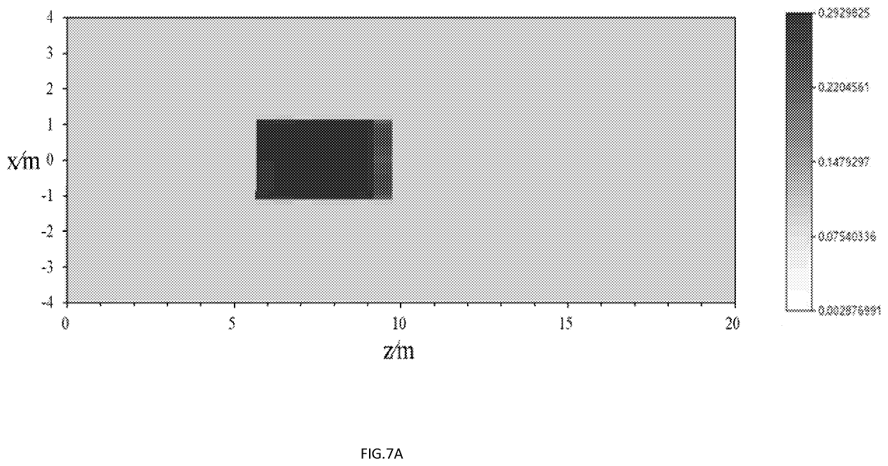

As a typical implementation method:
(i) establishing the geophysical model of the low-resistance body ahead of the tunnel is shown in FIG. 5. In this model, the low-resistance water-bearing body is located 5 meters ahead of the tunnel as the size of 2×3×2 meters. Four forward boreholes were arranged ahead of the tunnel, each equipped with 20 electrodes spaced 1 meter apart. Employing a four-borehole joint observation method, two sets of observation data—apparent resistivity

$${d}_{σ}^{o b s}$$

and apparent polarizability

$${d}_{η}^{o b s}$$

—were collected within a 20-meter range ahead of the tunnel. The inversion area was defined as 8×8×20 meters;
(ii) establishing a three-dimensional coordinate system ahead the tunnel with the center of the tunnel face as the origin, creating initial resistivity model

$${m}_{σ}^{( 0 )}$$

and polarizability model

$${m}_{η}^{( 0 )}$$

along with corresponding reference models,

$${m}_{σ}^{ref} , {m}_{η}^{ref}$$

and computing the smoothness matrix Wₘ and data weight matrix W_{d};
(iii) performing several linear resistivity inversions on the initial resistivity model

$${m}_{σ}^{( 0 )} ,$$

and using the inversion results as the initial resistivity model for the next step of joint resistivity-polarizability clustering inversion;
(iv) performing forward modeling on the initial polarizability model

$${m}_{η}^{( 0 )}$$

to obtain the initial polarizability prediction data

$${d}_{η}^{( 0 )} ,$$

then substituting into equation (1) to calculate the initial values of the polarizability boundary constraint parameter

$${λ}_{2}^{( 0 )} ;$$

(v) setting the initial cluster center vectors

$${v}_{k}^{( 0 )} : {v}_{k 1}^{( 0 )} = {( {v}_{k 1}^{( 0 )} , {v}_{k 1}^{( 0 )} , … , {v}_{k 1}^{( 0 )} )}_{1 \times M}^{T} , {v}_{k 2}^{( 0 )} = {( {v}_{k 2}^{( 0 )} , {v}_{k 2}^{( 0 )} , … , {v}_{k 2}^{( 0 )} )}_{1 \times M}^{T} , … , k ∈ [ 0 , C ] ,$$

wherein,

$${v}_{k 1}^{( 0 )}$$

is the first initial cluster center for the k^{th} class (resistivity value),

$${v}_{k 2}^{( 0 )}$$

is the second initial cluster center for the k^{th} class (polarizability value);
(vi) starting the clustering joint inversion iteration, computing the membership degree

$${u}_{j , k}^{q , ( n )}$$

for each unit in the model, and calculating the cluster center vector

$${v}_{k}^{( n )}$$

for each cluster using equation (3);
(vii) calculating the sensitivity matrix

$${J}_{σ}^{( n )}$$

for resistivity inversion and the sensitivity matrix

$${J}_{η}^{( n )}$$

for polarizability inversion in the n iteration;

$${J}_{η i , j} = \frac{{φ}_{σ}^{i}}{{( {φ}_{η}^{i} )}^{2}} \cdot - {σ}_{b j} \frac{\partial {φ}_{η}^{i}}{\partial {σ}_{j}} = - {σ}_{b j} \frac{{φ}_{σ}^{i}}{{( {φ}_{η}^{i} )}^{2}} {J}_{σ i , j} ;$$

wherein, J_{σ} is the sensitivity matrix of the apparent resistivity data with respect to the resistivity model which is calculated using conventional methods; J_{ηi,j} is the element in the i^{th} row and the j^{th} column in the matrix J_{η}, σ_{bj} represents the background conductivity of the j^{th} unit,

$${φ}_{σ}^{i}$$

represents the predicted data for the i^{th} unit without induced polarization effect, and

$${φ}_{η}^{i}$$

is the total predicted data for the i^{th} unit under induced polarization effect;
(viii) obtaining the increment of the resistivity model

$${m}_{σ}^{( n )}$$

in the n iteration and updating the resistivity model

$${m}_{σ}^{( n )} = {m}_{σ}^{( n - 1 )} + Δ {m}_{σ}^{( n )} ;$$

(ix) updating the values of the polarizability boundary constraint parameter

$${λ}_{2}^{( n )} ,$$

obtaining the polarizability model increment

$${m}_{η}^{( n )}$$

and updating the polarizability model

$${m}_{η}^{( n )} = {m}_{η}^{( n - 1 )} + γζΔ {m}_{η}^{( n )} ;$$

(x) performing forward modeling on the updated resistivity model

$${m}_{σ}^{( n )}$$

and polarizability model

$${m}_{η}^{( n )}$$

respectively to obtain the n^{th} iteration resistivity prediction data

$${d}_{σ}^{( n )}$$

and polarizability prediction data

$${d}_{η}^{( n )} .$$

taking difference between the corresponding prediction data from each set of observation resistivity and polarizability data to calculate the residuals

$$Δ {d}_{σ}^{( n )} and Δ {d}_{η}^{( n )} ;$$

(xi) calculating the fitting error RMS, RMS_IP for the n^{th} iteration, if the convergence condition is not satisfied, continuing looping steps (vi) to (xi); if the convergence condition is satisfied, concluding the inversion, outputting the apparent polarizability and apparent resistivity of the cross-section y=0 in the inversion results, and performing imaging of the tunnel ahead;
identifying whether there is water-bearing/water-conducting adverse geology ahead of the tunnel based on the boundary information of the water-bearing body indicated in the imaging results; and
when water-bearing/water-conducting adverse geology are identified ahead of the tunnel, employ the following methods, adopt but not limited to the following methods:
applying ring curtain grouting along the tunnel contour line to form a water-stop curtain;
grouting materials may be cement-sodium silicate double liquid slurry and other similar materials;
setting up interception ditches and water collection wells, and use multi-stage drainage pumps for timely pumping and drainage;
when the burial depth exceeds 20 meters, prioritizing in-tunnel grouting; or
laying waterproof membranes between the primary support and secondary lining, with water stop provided at construction joints.

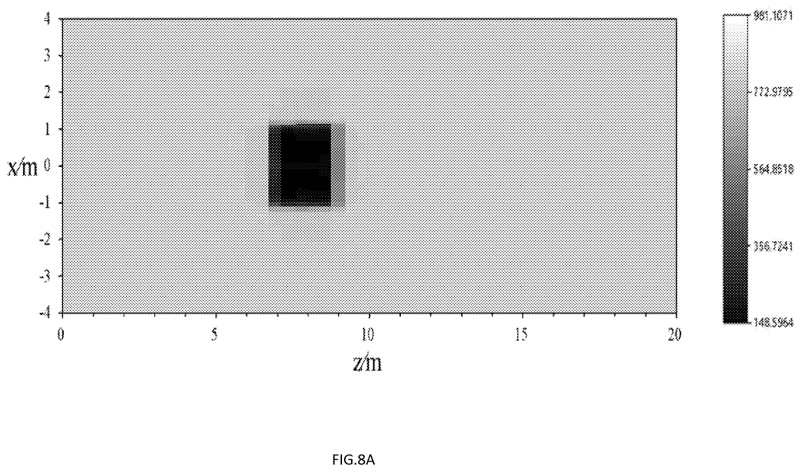

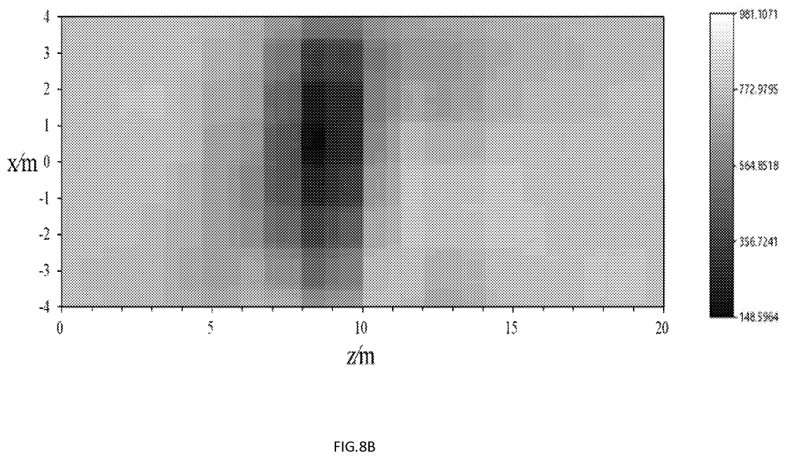

The present example compares imaging results obtained by the clustering joint inversion method with those from the traditional sequential inversion method. After performing 40 separate resistivity inversions on the initial model, the clustering joint inversion was conducted for 60 iterations. The inversion results are shown in FIG. 7A and FIG. 8A. Traditional sequential inversion was subsequently performed with 60 iterations for separate inversion for resistivity and separate inversion for polarizability. The inversion results are shown in FIG. 7B and FIG. 8B.

FIG. 7A and FIG. 7B, as well as FIG. 8A and FIG. 8B, respectively image the apparent polarizability and apparent resistivity outputs from the cross-section y=0 of the two inversion methods. Comparing the imaging outcomes reveals that the induced polarization clustering joint inversion method of the present invention can accurately delineate the boundary of the water-bearing area ahead of the tunnel.

For those skilled in the art, examples of the present invention may be provided as methods, systems, or computer program products. Therefore, the present invention may be embodied in the form of a fully hardware example, a fully software example, or an example combining both software and hardware aspects. Moreover, the present invention may be embodied as a computer program product implemented on one or more computer-readable storage media (including but not limited to disk storage, CD-ROM, optical storage, etc.) containing computer-executable program code.

The present invention is described with reference to flowcharts and/or block diagrams illustrating methods, apparatus (systems), and computer program products according to examples of the invention. It will be understood that each flow and/or block of the flowchart illustrations and/or block diagrams, and combinations of flows and/or blocks in the flowchart illustrations and/or block diagrams, can be implemented by computer program instructions. These computer program instructions may be provided to a processor of a general-purpose computer, a dedicated computer, an embedded processor, or other programmable data processing equipment to produce a machine, such that the instructions, which execute via the processor of the computer or other programmable data processing equipment, generate a device for implementing the functions specified in one or more processes of the flowchart and/or one or more blocks of the block diagram.

These computer program instructions may also be stored in computer-readable storage media capable of directing a computer or other programmable data processing apparatus to operate in a specific manner, such that the instructions stored therein produce an article of manufacture comprising an instruction device that implements the functions specified in one or more processes of the flowchart and/or one or more blocks of the block diagram.

These computer program instructions may also be loaded onto a computer or other programmable data processing apparatus, enabling the execution of a series of operational steps on the computer or other programmable apparatus to produce computer-implemented processing. Thus, the instructions executed on the computer or other programmable apparatus provide steps for implementing the functions specified in one or more processes of the flowchart and/or one or more blocks of the block diagram.

The foregoing description is merely an exemplary example of the present invention and is not intended to limit the scope of the invention. For those skilled in the art, various modifications and changes may be made to the invention. Any modifications, equivalent substitutions, improvements, or other changes made within the spirit and scope of the present invention shall be included within the scope of protection of the invention.

Although the specific examples of the present invention have been described with reference to the accompanying drawings, this description is not intended to limit the scope of protection of the invention. Those skilled in the art will understand that various modifications or variations made by persons skilled in the art based on the technical solutions of the present invention without requiring creative labor remain within the scope of protection of the present invention.

1. A method for arranging a water detection structure based on borehole-tunnel induced polarization, comprising the following steps:
arranging a plurality of forward boreholes along the outer edge area of a tunnel face;
respectively disposing in-borehole detection cables in each of the forward boreholes, the in-borehole detection cables having a plurality of detection electrodes;
for any two detection electrodes among the detection electrodes in each in-borehole detection cable, configuring them as a power supply electrode A and a power supply electrode B according to their distance relative to the tunnel face; wherein the detection electrode closer to the tunnel face is defined as a power supply electrode A, and the detection electrode farther from the tunnel face is defined as a power supply electrode B; that is, the power electrode A is located between the tunnel face and the power supply electrode B;
on the tunnel face, outside an area occupied by a plurality of the forward boreholes, a plurality of out-of-borehole detection electrodes are arranged in an array, selecting any two of the out-of-borehole detection electrodes, defining one as a measuring electrode M and the other as a measuring electrode N; and
the power supply electrode A and the power supply electrode B forming a power supply closed circuit, while the measuring electrode M and the measuring electrode N form a measuring closed circuit.

2. A water detection method based on inversion technology, implemented by a water detection structure arranged by a water detection structure based on borehole-tunnel induced polarization according to claim 1, further comprising:
an initial observation data acquisition step, for obtaining the induced polarizability data generated by the borehole-tunnel induced polarization water detection structure, comprising the following specific steps:
defining any one of a plurality of the forward boreholes as a first borehole;
selecting any two detection electrodes from the plurality of detection electrodes in the borehole detection cable in the first borehole, defining one as a power supply electrode A and the other as a power supply electrode B, and supplying power so that the power supply electrode A and the power supply electrode B form a power closed circuit; wherein the detection electrode closer to the tunnel face is defined as a power supply electrode A, and the detection electrode farther from the tunnel face is defined as a power supply electrode B, so that the power supply electrode A is located between the tunnel face and the power supply electrode B;
selecting any two electrodes from the plurality of out-of-borehole detection electrodes, defining one as a measuring electrode M and the other as a measuring electrode N, and supplying power to form a measuring closed circuit between the measuring electrode M and the measuring electrode N, thereby obtaining initial observation data under the state;
according to the above method, traversing and measuring each detection electrode from all the in-borehole detection cables in the first borehole and the out-of-borehole detection electrodes, thereby obtaining initial observation data based on the first borehole; and
according to the observation method based on the initial observation data of the first borehole, obtaining the corresponding initial observation data for the remaining boreholes sequentially.

3. The water detection method according to claim 2, further comprising:
an initial observation data screening step, for calculating the initial observation data of each borehole obtained by the initial observation data acquisition step, using the formula for geometric factor G, discarding corresponding initial observation data when G exceeds a preset threshold to generate detection observation data:
$$G = \frac{4 π}{( \frac{1}{AM} + \frac{1}{{AM}^{′}} - \frac{1}{AN} - \frac{1}{{AN}^{′}} - \frac{1}{BM} - \frac{1}{{BM}^{′}} + \frac{1}{BN} + \frac{1}{{BN}^{′}} )} ;$$
wherein, AM, AN, BM and BN respectively represent the distances between each power supply electrode and the measuring electrodes; AM′, AN′, BM′ and BN′ respectively represent the distances between the virtual electrode points, which are symmetrical to each power supply electrode with respect to the tunnel face, and the measuring electrodes.

4. The water detection method according to claim 3, wherein the preset value is 3000.

5. The water detection method according to claim 3, further comprising:
establishing a corresponding resistivity initial model and an initial polarizability model based on the detection observation data, performing conventional electrical inversion based on the resistivity initial model to obtain a resistivity inversion model;
establishing a tunnel resistivity-polarizability clustering joint inversion objective function;
based on the tunnel resistivity-polarizability clustering joint inversion objective function, finding the minimum value of the tunnel resistivity-polarizability clustering joint inversion objective function, constructing an inversion equation based on the objective function, updating model parameter increments, and obtaining a final inversion result after iterative inversion;
outputting apparent polarizability and apparent resistivity of the cross-section γ=0 in the inversion result to image the tunnel ahead;
identifying whether there is water-bearing/water-conducting adverse geology ahead the tunnel based on boundary information of the water-bearing body indicated in the imaging results; and
when water-bearing/water-conducting adverse geology is identified ahead the tunnel, taking measures such as grouting to stop water, water diversion, and drainage for the water-bearing/water-conducting adverse geology.

6. The water detection method according to claim 5, wherein the joint inversion objective function for the tunnel resistivity-polarizability clustering is:
$$Φ = {Φ}_{σ} + {μΦ}_{η} + {λ}_{1} {Φ}_{FCM} + {λ}_{2} {Φ}_{log} , {Φ}_{σ} = {Φ}_{d σ} + {β}_{σ} {Φ}_{m σ} , {Φ}_{η} = {Φ}_{d η} + {β}_{η} {Φ}_{m η} ;$$
wherein, Φ_{σ} is a sum of resistivity data terms and model terms for conventional inversion; Φ_{η} is a sum of polarizability data terms and model terms of conventional inversion; μ is a weighting parameter balancing the resistivity and polarizability model groups; Φ_{FCM} is a clustering term, λ₁ is a parameter determining a weight of the applied clustering term; Φ_{log} is a boundary constraint term, λ₂ is a boundary constraint parameter; β_{σ} and β_{η} are regularization parameters; Φ_{dσ} is a resistivity data term, Φ_{mσ} is a resistivity model term, Φ_{dη} is a polarizability data term, and Φ_{mη} is a polarizability model term.

7. The water detection method according to claim 6, wherein:
$${Φ}_{FCM} = {{\sum }_{j = 1}}^{M} {{\sum }_{k = 1}}^{C} {u}_{jk}^{q} ( {‖ {m}_{σ , j} - {v}_{k 1} ‖}^{2} + ξ {‖ {m}_{η , j} - {v}_{k 2} ‖}^{2} ) + {{\sum }_{k = 1}}^{C} ω {‖ {v}_{k} - {t}_{k} ‖}^{2} ;$$
wherein, m_{σ} is a resistivity vector of the model, m_{η} is a polarizability vector of the model, vₖ₁ is a first cluster center representing the resistivity value of the k^{th} class, vₖ₂ is a second cluster center representing the polarizability value of the k^{th} class, and the vₖ₁ and vₖ₂ are added according to a weight ξ;
$${u}_{jk}^{q}$$
is membership degree of the j^{th} unit relative to the k^{th} class; tₖ represents target a cluster center provided by known prior petrophysical information, in the vector ω=(ω₁, ω₂, . . . , ωₖ)^{T}, the magnitude of each parameter element ωₖ determined by the reliability of the k^{th} prior cluster center; q is a fuzzification factor as a constant.

8. The water detection method according to claim 7, wherein:
$${Φ}_{log} = - 2 \{ {{\sum }_{k = 1}}^{M} ln ( \frac{{m}_{η}}{u} ) + {{\sum }_{k = 1}}^{M} ln ( 1 - \frac{{m}_{η}}{u} ) \} ;$$
wherein, u represents the upper bound of the constraint, and M denotes the number of the model parameters;
$${u}_{jk}^{q} = \frac{{‖ {m}_{σ} - {v}_{k 1} ‖}^{- \frac{2}{q - 1}} + ξ {‖ {m}_{η} - {v}_{k 2} ‖}^{- \frac{2}{q - 1}}}{{\sum }_{i = 1}^{C} ( {‖ {m}_{σ} - {v}_{i 1} ‖}^{- \frac{2}{q - 1}} + ξ {‖ {m}_{η} - {v}_{i 2} ‖}^{- \frac{2}{q - 1}} )} ;$$
$$and ,$$
$${v}_{k 1} = \frac{{\sum }_{j = 1}^{M} {u}_{jk}^{q} {m}_{σ , j} + {ω}_{k} {t}_{k}}{{\sum }_{j = 1}^{M} {u}_{jk}^{q} + {ω}_{k}} , {v}_{k 2} = \frac{{\sum }_{j = 1}^{M} {u}_{jk}^{q} {m}_{η , j} + {ω}_{k} {t}_{k}}{{\sum }_{j = 1}^{M} {u}_{jk}^{q} + {ω}_{k}} .$$

9. The water detection method according to claim 8, wherein:
an inversion equation for a resistivity model increment Δm_{σ} is:
$$( {J}_{σ}^{T} {W}_{d}^{T} {W}_{d} {J}_{σ} + {β}_{σ} {W}_{m}^{T} {W}_{m} + {λ}_{1} {{\sum }_{k = 1}}^{C} {U}_{k} ) Δ {m}_{σ} = {J}_{σ}^{T} {W}_{d}^{T} {W}_{d} Δ {d}_{σ} - {β}_{σ} {W}_{m}^{T} {W}_{m} ( {m}_{σ} - {m}_{σ}^{ref} ) - {λ}_{1} {{\sum }_{k = 1}}^{C} {U}_{k} ( {m}_{σ} - {v}_{k 1} ) ;$$
wherein, J_{σ} is a sensitivity matrix for resistivity, β_{σ} is a damping factor as a constant based on experience for the constraint term of the resistivity model, C is the number of clusters, Uₖ is a membership degree matrix of a grid belonging to the k^{th} cluster, Δd_{σ} is a data difference vector for resistivity, which is the difference between measured and predicted data, m_{σ} is a resistivity value,
$${m}_{σ}^{ref}$$
is a reference resistivity model, and vₖ₁ is a resistivity cluster center for the k^{th} cluster;
and,
an iterative updating equation for a polarizability boundary constraint parameter λ₂ is:
$$\{ \begin{matrix}{ζ}_{-} = {min}_{Δ {m}_{j} < 0} \frac{{m}_{j}}{\vert Δ {m}_{j} \vert} \\ {ζ}_{+} = {min}_{Δ {m}_{j} > 0} \frac{u - {m}_{j}}{Δ {m}_{j}}\end{matrix} , ζ = min ( {ζ}_{-} , {ζ}_{+} ) , {λ}_{2} = {λ}_{2} [ 1 - min ( γ , ζ ) ] ;$$
wherein, λ₋ and λ₊ represent two intermediate variables, and the final calculation ζ is also an intermediate coefficient used to update λ₂; γ is a constant.

10. The water detection method according to claim 9, wherein:
an inversion equation for a polarizability model increment Δm_{η} is:
$$( {J}_{η}^{T} {W}_{d}^{T} {W}_{d} {J}_{η} + {β}_{η} {W}_{m}^{T} {W}_{m} + {λ}_{1} {{\sum }_{k = 1}}^{C} {U}_{k} + {λ}_{2} {X}^{- 2} + {λ}_{2} {Y}^{- 2} ) Δ {m}_{η} = {J}_{η}^{T} {W}_{d}^{T} {W}_{d} Δ {d}_{η} - {β}_{η} {W}_{m}^{T} {W}_{m} ( {m}_{η} - {m}_{η}^{ref} ) - {λ}_{1} {{\sum }_{k = 1}}^{C} {U}_{k} ( {m}_{η} - {v}_{k 2} ) + {λ}_{2} ( {X}^{- 1} - {Y}^{- 1} ) e ;$$
wherein,
$$x = diag ( {m}_{1} , {m}_{2} , … , {m}_{M} ) , Y = uI - X , e = {[ 11 L 1 ]}_{M}^{T} ;$$
wherein, J_{η} is a sensitivity matrix for the polarizability, Δd_{η} is a difference vector of the observed polarizability data, which is the difference between the observed and the predicted polarizability data, vₖ₂ is a polarizability cluster center for the k^{th} cluster, and e is an M-dimensional column vector;
$${λ}_{2} = \frac{{‖ {W}_{d} ( {d}_{η}^{obs} - {d}_{η} ) ‖}^{2} + {β}_{η} {‖ {W}_{m} ( {m}_{η} - {m}_{η}^{ref} ) ‖}^{2}}{- 2 {\sum }_{j = 1}^{M} [ ln ( \frac{{m}_{η , j}}{u} ) + ln ( 1 - \frac{{m}_{η , j}}{u} ) ]} ;$$
wherein, W_{d} is a data weighting matrix,
$${d}_{η}^{obs}$$
is an observed polarizability data, d_{η} is a simulated polarizability data, β_{η}, is a damping factor for the polarizability model constraint term, Wₘ is a smoothness constraint matrix, m_{η} is the polarizability,
$${m}_{η}^{ref}$$
is a reference model for polarizability, and u is an upper bound for polarizability.
